(19) United States
(12) Patent Application Publication
(10) Pub. No.: US 2024/0385581 A1
(43) Pub. Date: Nov. 21, 2024

(54) TEST CONDITION DETERMINATION DEVICE

(71) Applicant: DAIKIN INDUSTRIES, LTD., Osaka (JP)

(72) Inventor: TakayukI NAKAHARA, Osaka (JP)

(21) Appl. No.: 18/785,865

(22) Filed: Jul. 26, 2024

Related U.S. Application Data
(63) Continuation of application No. PCT/JP2023/003213, filed on Feb. 1, 2023.

(30) Foreign Application Priority Data
Feb. 8, 2022 (JP) 2022-017726

(51) Int. Cl. G05B 19/042

(52) U.S. Cl. CPC G05B 19/0428; G05B 2219/25011

(57) ABSTRACT

A test condition determination device determines a test condition for a facility device. The facility device is assigned with tag information for each item of data. The test condition determination device includes a control unit, and a storage unit that stores a database in which the tag information and the test condition are associated with each other. The control unit acquires the tag information from the facility device, and determines the test condition from the acquired tag information and the database.

### CROSS-REFERENCE TO RELATED APPLICATIONS

This is a continuation of Application No. PCT/JP2023/003213 filed on Feb. 1, 2023, which claims priority to Japanese Patent Application No. 2022-017726, filed on Feb. 8, 2022. The entire disclosures of these applications are incorporated by reference herein.

### BACKGROUND

### Technical Field

The present invention relates to a test condition determination device for determining a test condition for a facility device.

### Background Art

There is a test called loop test as one of tests for confirming soundness of content of communication between a facility such as an air conditioner and a facility such as a building management system for monitoring the facility.

When a loop test is to be performed, a test operator has conventionally been required, on a facility side, to output a test signal using a tool that is different depending on a model, as well as to output a test signal using a method that is different depending on a facility.

To simplify a task relating to a loop test, a device disclosed in Japanese Unexamined Patent Application Publication No. 2017-191386, for example, includes a setting operation unit and an execution operation unit. The setting operation unit makes it possible to set a test pattern for changing an output signal to be outputted from the device as time passes by. The execution operation unit causes the device to output an output signal based on the set test pattern.

As a result, burden on the test operator is reduced in terms of “time and effort for performing setting using a method unique to each facility” and “time and effort for setting a signal pattern for an item of data that each facility possesses”.

### SUMMARY

However, there are still “time and effort for setting a signal pattern for an item of data (or for making a selection from among existing signal patterns)”, and, furthermore, there is a risk of a pattern setting error, since such setting is performed manually by a person.

Therefore, there is an issue of providing a test condition determination device that makes it possible to avoid a pattern setting error when a signal pattern is to be set for an item of data.

A test condition determination device according to a first aspect is a test condition determination device for determining a test condition for a facility device, the facility device being assigned with tag information for each item of data. The test condition determination device includes a control unit and a storage unit. The storage unit stores a database in which the tag information and the test condition are associated with each other. The control unit acquires the tag information from the facility device, and determines the test condition from the acquired tag information and the database.

### BRIEF DESCRIPTION OF THE DRAWINGS

FIG. 1 is a schematic configuration diagram of a monitoring control system for a refrigeration apparatus.

FIG. 2 is a block diagram illustrating schematic configurations of a test device, a monitoring control device, and a chiller.

FIG. 3 is a table illustrating items of data transmitted from the chiller to the monitoring control device and test signal patterns.

FIG. 4 is a flowchart for determining a test signal pattern.

FIG. 5 is a table illustrating an example of pieces of tag information assigned to items of data.

FIG. 6 is a conceptual diagram of a database of pieces of tag information and test signal patterns associated with the pieces of tag information.

FIG. 7 is a table illustrating test signal pattern candidates displayed on a display of the test device.

FIG. 8 is a table illustrating test signal pattern candidates displayed on the display of the test device after similar tag information is permitted to be retrieved from the database.

FIG. 9 is a table after some of the test signal patterns displayed on the display have been selected.

### DETAILED DESCRIPTION OF EMBODIMENT(S)

### (1) Schematic Configuration of Monitoring Control System 1 for Refrigeration Apparatus

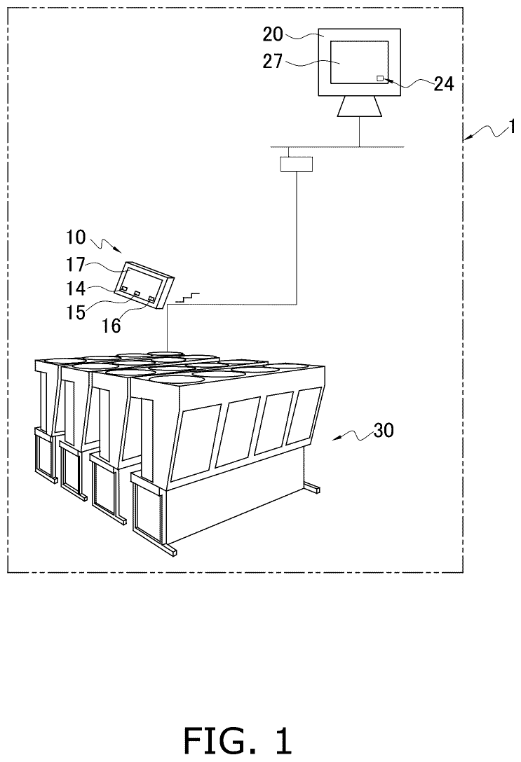

FIG. 1 is a schematic configuration diagram of a monitoring control system 1 for a refrigeration apparatus. In FIG. 1, the monitoring control system 1 for the refrigeration apparatus includes a test device 10, a monitoring control device 20, and a chiller 30 serving as the refrigeration apparatus. Information is transmitted and received among the test device 10, the monitoring control device 20, and the chiller 30 through communication.

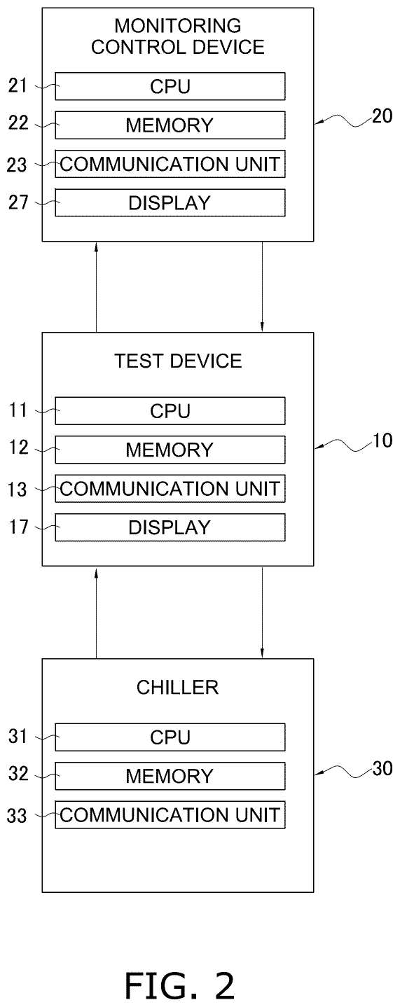

FIG. 2 is a block diagram illustrating schematic configurations of the test device 10, the monitoring control device 20, and the chiller 30. Furthermore, FIG. 2 mainly illustrates parts relating to functions of the monitoring control system 1 according to the present invention, and illustration of other detailed parts is omitted.

In FIG. 2, the test device 10 includes a central processing unit (CPU) 11, a memory 12, a communication unit 13, and a display 17.

The CPU 11 processes information acquired through communication with the chiller 30, for example. The memory 12 stores the information processed by the CPU 11 and information acquired by the CPU 11.

The communication unit 13 transmits and receives necessary information to and from the monitoring control device 20 and the chiller 30. The display 17 is a screen that outputs read information or information inputted by a user, for example.

The monitoring control device 20 includes a CPU 21, a memory 22, a communication unit 23, and a display 27.

The CPU 21 processes information acquired through communication with the test device 10 and the chiller 30, for example. The memory 22 stores information processed by the CPU 21 and information acquired by the CPU 21.

The display 27 is a screen that outputs read information or information inputted by the user, for example. Buttons 24 (see FIG. 1) are displayed on the display 27, allowing the user to set and input predetermined information.

The chiller 30 includes a CPU 31, a memory 32, and a communication unit 33. The CPU 31 processes information acquired via the communication unit 33 and information stored in the memory 32.

The memory 32 stores information processed by the CPU 31 and information acquired by the CPU 31 as setting information. Note that the setting information includes all types of information necessary for operating the chiller 30.

The communication unit 33 transmits and receives necessary information to and from the communication unit 13 in the test device 10.

### (2) Test Device 10

The test device 10 performs a loop test as a test for confirming soundness of content of communication between the chiller 30 and the monitoring control device 20 that monitors and controls the chiller 30. In the loop test, the test device 10 causes a facility to generate a test signal to check soundness of content of communication.

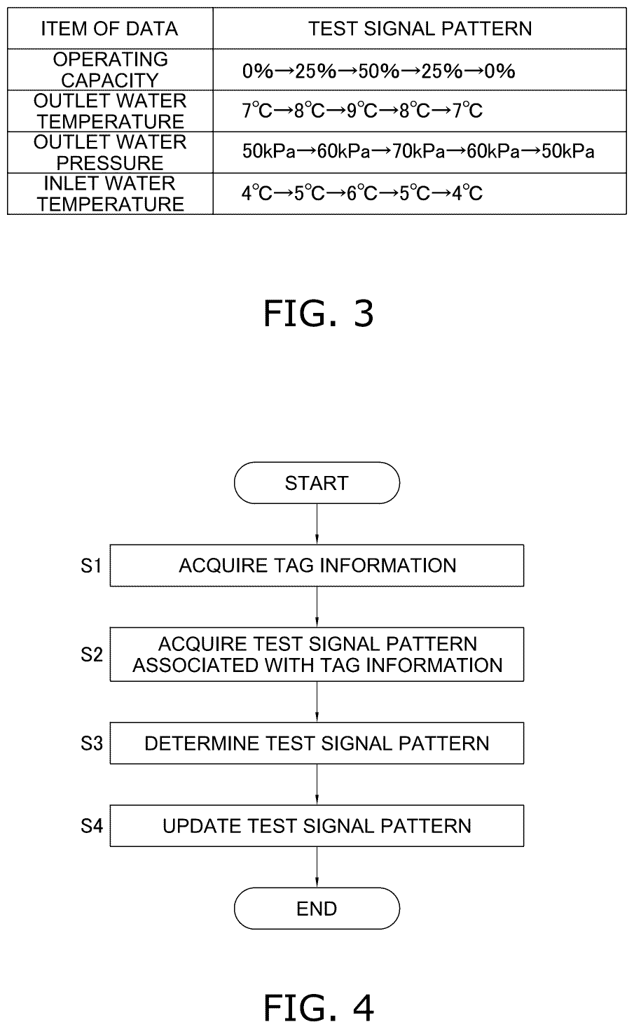

FIG. 3 is a table illustrating items of data transmitted from the chiller 30 to the monitoring control device 20 and test signal patterns. In FIG. 3, types of data actually measured in the chiller 30 are operating capacity, an outlet water temperature, outlet water pressure, and an inlet water temperature.

In an ordinary facility device, a test signal pattern is determined in advance for each item of data to confirm that measured data is transmitted to the monitoring control device 20 in a sound manner.

Also in the chiller 30 according to the present embodiment, as illustrated in FIG. 3, a test signal pattern for “operating capacity” is a pattern in which signals indicating 0%, 25%, 50%, 25%, and 0% of full capacity are to be sequentially outputted.

A test signal pattern for “outlet water temperature” is a pattern in which signals indicating 7° C., 8° C., 9° C., 8° C., and 7° C. are to be sequentially outputted.

A test signal pattern for “outlet water pressure” is a pattern in which signals indicating 50 kPa, 60 kPa, 70 kPa, 60 kPa, and 50 kPa are to be sequentially outputted.

A test signal pattern for “inlet water temperature” is a pattern in which signals indicating 4° C., 5° C., 6° C., 5° C., and 4° C. are to be sequentially outputted.

A reason of why signals are not constant even for one item of data, as described above, is that, in the case of the operating capacity, for example, there may be a situation in which a signal relating to 25% is normally transmitted, but a signal relating to 50% is not normally transmitted.

A service person may directly operate the chiller 30 and transmit a test signal to the monitoring control device 20 in accordance with a method that has been set in the chiller 30. However, workability is significantly reduced due to its time and effort.

Therefore, the service person communicably couples the test device 10 to the chiller 30, causes a necessary test signal pattern to be automatically set, and causes test signals to be transmitted from the chiller 30 to the monitoring control device 20.

### (2-1) Method of Determining Test Signal Pattern

Tag information for identification is assigned to each item of necessary data in not only the chiller 30, but also other facility devices. In the present embodiment, determining a test signal pattern starts as the test device 10 acquires tag information from the chiller 30.

The “tag information” described in the present application is set separately from a name of data, and tags relating to substances such as water (#water) and air (#air), physical quantities such as temperature (#temperature) and pressure (#pressure), measurement locations such as outlet (#leaving) and inlet (#entering), and state information of a device such as operating capacity (#capacity) are determined in advance, providing information relating to a meaning of data (data relating to a target that has been measured and a location at which the target has been measured) by combining and assigning such tags.

Furthermore, although it is possible to infer a meaning of data to some extent from a name of the data, the name of the data is designated for each device (by each manufacturer), resulting in complication in determining similarity in name of data among different types of devices, as well as resulting in difficulty in reusing a signal pattern.

For the “tag information” described in the present application, on the other hand, a necessary tag is assigned from predetermined tags to each piece of data relating to a device, resulting in easiness in determining similarity in tag information even when there is a slight difference among devices, as well as resulting in easiness in reusing a signal pattern.

FIG. 4 is a flowchart for determining a test signal pattern. Operation of determining a test signal pattern by the test device 10 will now be described herein with reference to FIG. 4.

### (Step S1)

The CPU 11 acquires tag information assigned to each item of data that the chiller 30 holds through communication with the chiller 30 via the communication unit 13.

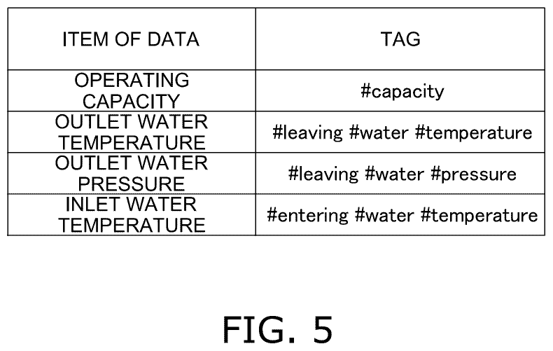

FIG. 5 is a table illustrating an example of pieces of tag information assigned to items of data. For example, the item of the data “operating capacity”, the item of the data “outlet water temperature”, the item of the data “outlet water pressure”, and the item of the data “inlet water temperature” are assigned with a tag “#capacity”, tags “#leaving #water #temperature”, tags “#leaving #water #pressure”, and tags “#entering #water #temperature”, respectively.

### (Step S2)

The CPU 11 acquires, from the database stored in the memory 12, tag information that there is a match and a test signal pattern associated with the tag information.

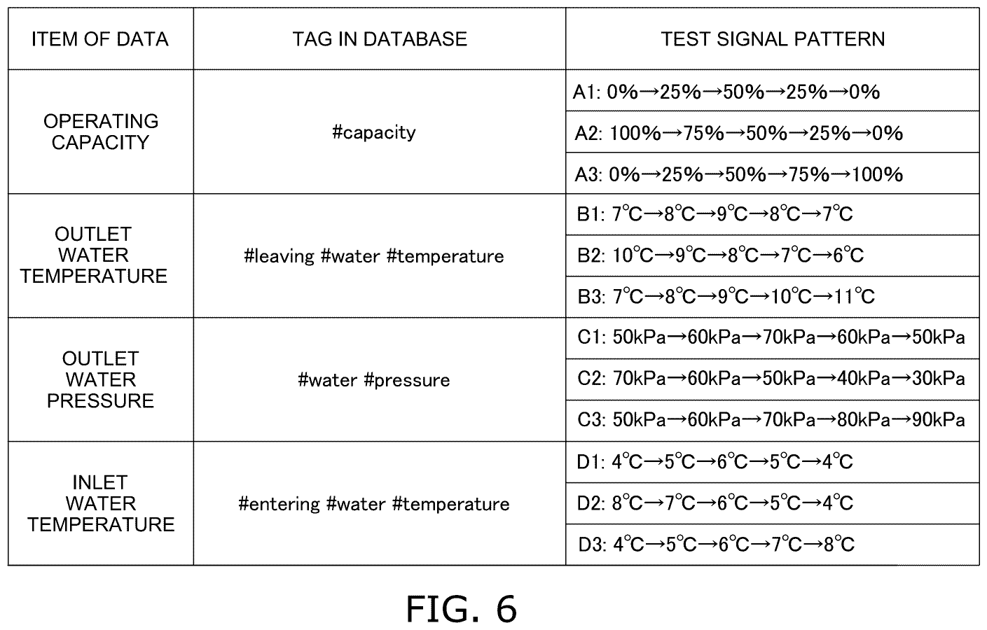

FIG. 6 is a conceptual diagram of a database of pieces of tag information and test signal patterns associated with the pieces of tag information. In FIG. 6, the item of the data “operating capacity”, the item of the data “outlet water temperature”, the item of the data “outlet water pressure”, and the item of the data “inlet water temperature” stored in the memory 12 are assigned with the tag information “#capacity”, the tag information “#leaving #water #temperature”, the tag information “#water #pressure”, and the tag information “#entering #water #temperature”, respectively.

In the case of the operating capacity, test signal patterns associated with each piece of tag information are three patterns of A1 to A3. Under the pattern A1, signals indicating 0%, 25%, 50%, 25%, and 0% of the full capacity are to be sequentially outputted. Under the pattern A2, signals indicating 100%, 75%, 50%, 25%, and 0% of the full capacity are to be sequentially outputted. Under the pattern A3, signals indicating 0%, 25%, 50%, 75%, and 100% of the full capacity are to be sequentially outputted.

In the case of the outlet water temperature, test signal patterns are three patterns of B1 to B3. Under the pattern B1, signals indicating 7° C., 8° C., 9° C., 8° C., and 7° C. are to be sequentially outputted. Under the pattern B2, signals indicating 10° C., 9° C., 8° C., 7° C., and 6° C. are to be sequentially outputted. Under the pattern B3, signals indicating 7° C., 8° C., 9° C., 10° C., and 11° C. are to be sequentially outputted.

In the case of the outlet water pressure, test signal patterns are three patterns of C1 to C3. Under the pattern C1, signals indicating 50 kpa, 60 kpa, 70 kpa, 60 kpa, and 50 kpa are to be sequentially outputted. Under the pattern C2, signals indicating 70 kpa, 60 kpa, 50 kpa, 40 kpa, and 30 kpa are to be sequentially outputted. Under the pattern C3, signals indicating 50 kpa, 60 kpa, 70 kpa, 80 kpa, and 90 kpa are to be sequentially outputted.

In the case of the inlet water temperature, test signal patterns are three patterns of D1 to D3. Under the pattern D1, signals indicating 4° C., 5° C., 6° C., 5° C., and 4° C. are to be sequentially outputted. Under the pattern D2, signals indicating 8° C., 7° C., 6° C., 5° C., and 4° C. are to be sequentially outputted. Under the pattern D3, signals indicating 4° C., 5° C., 6° C., 7° C., and 8° C. are to be sequentially outputted.

From FIGS. 5 and 6, it can be seen that the tag information “outlet water pressure” assigned to the chiller 30 does not match the tag information “outlet water pressure” that the test device 10 is holding.

### (Step S3)

The CPU 11 determines a test signal pattern to be actually adopted based on the tag information acquired from the chiller 30 and a test signal pattern associated with the tag information held in the database.

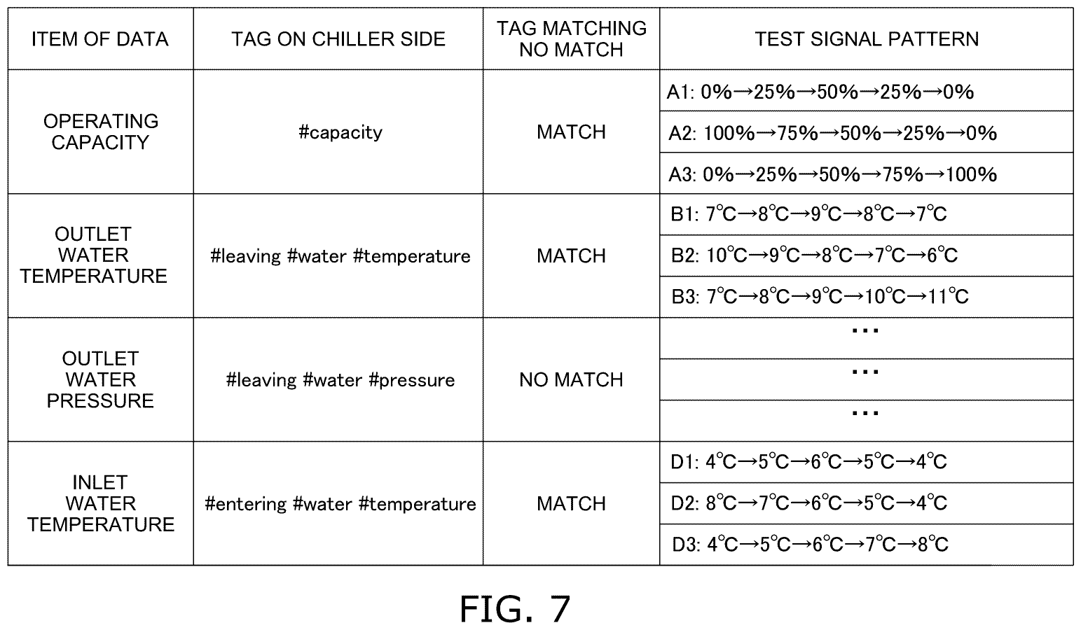

FIG. 7 illustrates test signal pattern candidates displayed on the display 17 of the test device 10. In FIG. 7, since the tag information #leaving #water #pressure relating to “outlet water pressure” assigned to the chiller 30 does not match the tag information #water #pressure relating to “outlet water pressure” that the test device 10 is holding, test signal pattern candidates for “outlet water pressure” are not displayed.

Therefore, the service person sets a test pattern signal for “outlet water pressure” for which there are no candidates. The service person presses a first button 14 (see FIG. 1) on the display 17 to permit tag information similar to #leaving #water #pressure to be retrieved from the database.

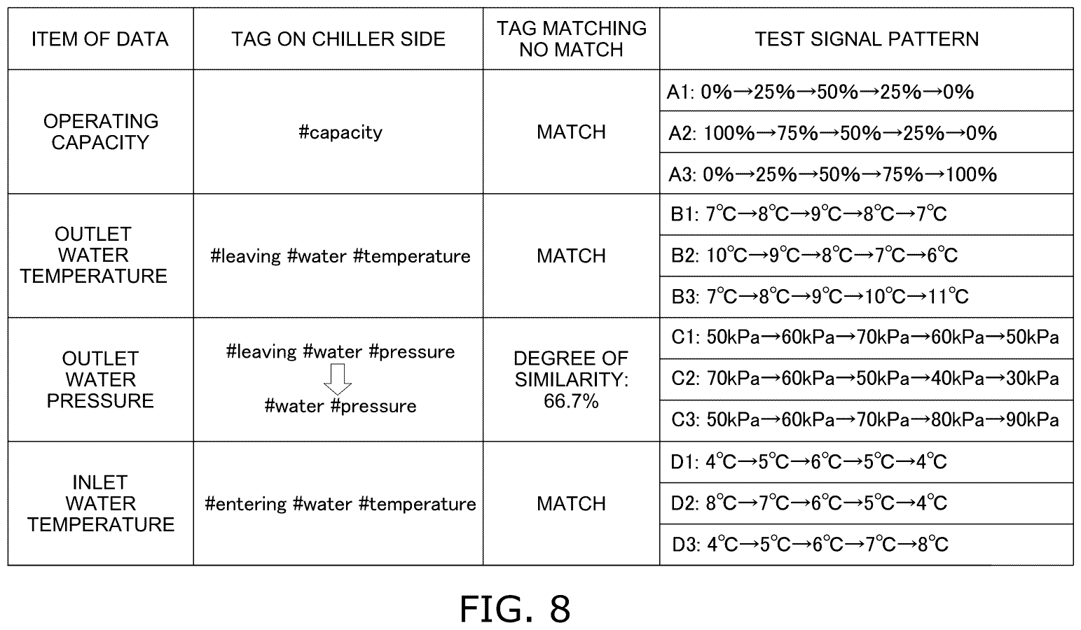

FIG. 8 is a table illustrating test signal pattern candidates displayed on the display 17 of the test device 10 after similar tag information is permitted to be retrieved from the database. In FIG. 8, test signal pattern candidates associated with the tag information #water #pressure held in the database in the test device 10 are displayed, for test pattern signals for “outlet water pressure” for which no candidates are displayed in FIG. 7.

Since two tags in the tag information #water #pressure relating to “outlet water pressure” that the test device 10 is holding match the tag information #leaving #water #pressure relating to “outlet water pressure” assigned to the chiller 30, a degree of similarity is (⅔)×100=66.7%. In the present embodiment, a degree of similarity of 60% or higher is used for similarity determination.

The service person selects a desired pattern from the test signal pattern candidates displayed for each item of data. Since the display 17 displays a table identical to that illustrated in FIG. 8, it may be sufficient that the service person touch and select a desired candidate.

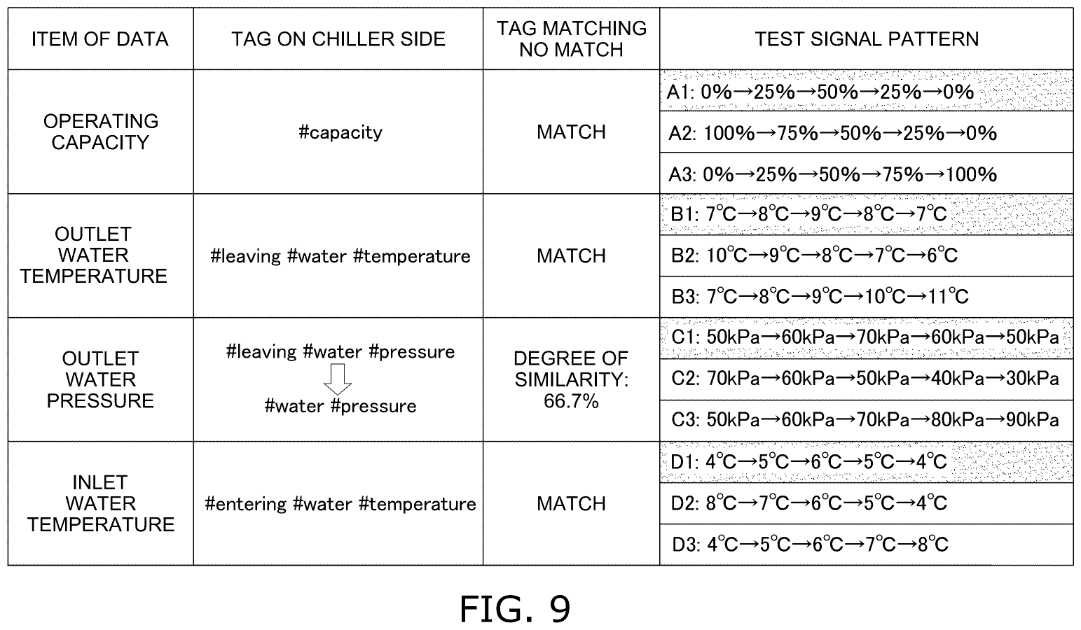

FIG. 9 is a table after some of the test signal patterns displayed on the display 17 have been selected. In FIG. 9, the selected test signal patterns are highlighted.

As the service person presses a second button 15 (see FIG. 1) on the display 17, the selected test signal pattern is set on the chiller 30 side, allowing the loop test to start.

The service person is able to desirably set a number of repetitions of the test signal pattern from the chiller 30 to the monitoring control device 20 via the display 17. Furthermore, instead of the number of repetitions of a test signal pattern, it is possible to desirably set an elapsed time of the test signal pattern.

### Step S4

The CPU 11 updates the database in the memory 12 to allow the determined test signal pattern to be associated with the tag information assigned to the item of data. Specifically, when the service person presses a third button 16 (see FIG. 1) on the display 17, the database in the memory 12 is updated and stored as data to be utilized later.

Since the test device 10 automatically determines a signal pattern for a loop test based on a test signal pattern associated with tag information, as described above, operational person-hours for setting a test signal pattern is reduced.

### (3) Feature

(3-1)

In the test device 10, the CPU 11 acquires tag information from the chiller 30, and determines a signal pattern for a loop test from the acquired tag information and a database in which the tag information and a test signal pattern are associated with each other. Therefore, operation of setting a signal pattern for a loop test, which is to be performed by the service person, is simplified, reducing operational person-hours, as well as reducing setting errors.

(3-2)

In the test device 10, it is possible to set not only a test signal pattern which the chiller 30 outputs, but also the number of repetitions of the test signal pattern or the elapsed time.

(3-3)

The test device 10 determines a test signal pattern associated with a higher degree of similarity to the tag information, when there is no match with the tag information in the database. This improves the test device 10 in versatility.

(3-4)

In the test device 10, the database is updated to allow the test signal pattern that has been determined to be associated with the tag information assigned to the item of data. This further improves the test device 10 in versatility.

(3-5)

A series of operation steps, which are acquiring tag information->determining a test signal pattern->performing setting->performing execution, proceeds in a determined order in the test device 10, reducing operational person-hours for the operator.

(3-6)

In the test device 10, the CPU 11 receives one pattern selected from among a plurality of test signal patterns.

(3-7)

The tag information is information that is assigned to each item of data measured and stored while the facility device such as the chiller 30 is operating and that includes one or more tags representing a meaning of the data.

(3-8)

In the test device 10, the display 17 displays the tag information that the CPU 11 has acquired, a degree of similarity between the tag information and the tag information in the database, and the test signal pattern that the CPU 11 has determined. Therefore, the service person is able to carry out a task more smoothly.

(3-9)

The test device 10 provides, when a candidate of the test signal pattern is not selectable, the first button 14 for newly setting a test signal pattern associated with similar tag information via the display unit. Thus, a means of allowing the service person to take an action at the site is provided, making it possible to save unnecessary time and effort, and facilitating updating of the database with a test signal pattern newly set.

(3-10)

The test signal pattern is a condition for evaluating soundness of content of communication between the chiller 30 and the monitoring control device 20 that monitors the chiller 30.

### (4) Modification Examples

When the tag information assigned to the chiller 30 does not match the tag information that the test device 10 is holding, in the test device 10 according to the present embodiment described above, it is possible to retrieve, from the database, similar tag information at a degree of similarity of 60% or higher.

However, there may be a case where there is no similar tag information at all. In such a case, the service person is able to lower the degree of similarity from “60% or higher” to “30% or higher”, expand a range of allowable similarity, and retrieve one from the database. It is possible to change the degree of similarity via the display 17.

Then, the service person himself or herself determines a desired test signal pattern only when no similar tag information is retrieved and no test signal pattern candidates appear, even when the degree of similarity has been lowered.

As the service person associates a desired test signal pattern that the service person himself or herself has determined with the tag information for which there is no match, and presses the third button 16 on the display 17, the database is updated to allow the desired test signal pattern that the service person himself or herself has determined is associated with the tag information. This further improves the test device 10 in versatility.

### (5) Other

In the present embodiment and the modification examples described above, it has been described that a loop test is performed to confirm soundness of content of communication between a facility and a monitoring system when construction takes place (when the building monitoring system has been constructed).

However, a loop test is not only executed when construction takes place, and a loop test is executed even during operation. For example, since, when facilities have been increased or decreased in number in a network after operation has been started, a situation of communication via the network changes, a loop test is performed to check whether or not there are changes in connectivity and response time to check whether or not the changes affect the existing devices. A loop test in this case is performed using a signal pattern determined when construction takes place.

While the embodiment of the present disclosure has been described above, it will be understood that various changes in form and detail may be made therein without departing from the spirit and scope of the present disclosure as set forth in the appended claims.

Although, in the present disclosure, the chiller has been described as an application example, the present disclosure is not limited to the chiller, and is generally applied to facility devices to which tag information is assigned.

1. A test condition determination device configured to determine a test condition for a facility device, the facility device being assigned with tag information for each item of data, the test condition determination device comprising:
a control unit; and
a storage unit that stores a database in which the tag information and the test condition are associated with each other,
the control unit being configured to
acquire the tag information from the facility device, and
determine the test condition from the acquired tag information and the database.

2. The test condition determination device according to claim 1, wherein
the test condition includes an elapsed time and a signal pattern output by the facility device.

3. The test condition determination device according to claim 1, wherein
the control unit is configured to determine the test condition associated with a higher degree of similarity to the tag information when there is no match with the tag information in the database.

4. The test condition determination device according to claim 1, wherein
the control unit is configured to update the database to allow the test condition that has been determined or the test condition that a user has desirably set to be associated with the tag information assigned to the item.

5. The test condition determination device according to claim 1, wherein
the control unit is configured to cause the facility device to perform a test based on the test condition.

6. The test condition determination device according to claim 1, wherein
the tag information in the database is associated with a plurality of the test conditions that are selectable, and
the control unit receives one of the test conditions, the one of the test conditions being selected from the plurality of test conditions.

7. The test condition determination device according to claim 1, wherein
the tag information is information that is assigned to the item of data measured and stored while the facility device is operating and that includes one or more tags representing a meaning of the data.

8. The test condition determination device according to claim 1, further comprising:
a display unit, the display unit being configured to display
the tag information that the control unit has acquired,
a degree of similarity between the tag information and the tag information in the database, and
the test condition that the control unit has determined.

9. The test condition determination device according to claim 8, wherein
when the test condition is not selectable, the control unit is configured to provide a button for newly setting a test condition via the display unit.

10. The test condition determination device according to claim 1, wherein
the test condition is a condition usable to evaluate soundness of content of communication between the facility device and a monitoring device that monitors the facility device.

11. The test condition determination device according to claim 2, wherein
the control unit is configured to determine the test condition associated with a higher degree of similarity to the tag information when there is no match with the tag information in the database.

12. The test condition determination device according to claim 2, wherein
the control unit is configured to update the database to allow the test condition that has been determined or the test condition that a user has desirably set to be associated with the tag information assigned to the item.

13. The test condition determination device according to claim 2, wherein
the control unit is configured to cause the facility device to perform a test based on the test condition.

14. The test condition determination device according to claim 2, wherein
the tag information in the database is associated with a plurality of the test conditions that are selectable, and
the control unit receives one of the test conditions, the one of the test conditions being selected from the plurality of test conditions.

15. The test condition determination device according to claim 2, wherein
the tag information is information that is assigned to the item of data measured and stored while the facility device is operating and that includes one or more tags representing a meaning of the data.

16. The test condition determination device according to claim 2, further comprising:
a display unit, the display unit being configured to display
the tag information that the control unit has acquired,
a degree of similarity between the tag information and the tag information in the database, and
the test condition that the control unit has determined.

17. The test condition determination device according to claim 16, wherein
when the test condition is not selectable, the control unit is configured to provide a button for newly setting a test condition via the display unit.

18. The test condition determination device according to claim 2, wherein
the test condition is a condition usable to evaluate soundness of content of communication between the facility device and a monitoring device that monitors the facility device.
